(19) United States
(12) Patent Application Publication
(10) Pub. No.: US 2024/0029046 A1
(43) Pub. Date: Jan. 25, 2024

(54) WIRELESS TAG READER DATA PROCESSING APPARATUS

(71) Applicant: Toshiba Tec Kabushiki Kaisha, Tokyo (JP)

(72) Inventor: Hideaki SUGIYAMA, Izunokuni Shizuoka (JP)

(21) Appl. No.: 18/336,833

(22) Filed: Jun. 16, 2023

(30) Foreign Application Priority Data
Jul. 25, 2022 (JP) 2022-118035

(51) Int. Cl. G06Q 20/20; G06K 7/10

(52) U.S. Cl. CPC G06Q 20/208; G06K 7/10366

(57) ABSTRACT

A wireless tag reader data processing apparatus includes a reading device interface configured to receive data read from wireless tags by a reading device and a user input device interface configured to receive data from a user input device. A processor is configured to disable an input from the user input device while the reading device is reading the data of the wireless tag. The wireless tag reader data processing apparatus in some examples may be incorporated into a point-of-sale terminal.

### CROSS-REFERENCE TO RELATED APPLICATION

This application is based upon and claims the benefit of priority from Japanese Patent Application No. 2022-118035, filed Jul. 25, 2022, the entire contents of which are incorporated herein by reference.

### FIELD

Embodiments described herein relate generally to a wireless tag reader data processing apparatus and a program for wireless tag reader data processing.

### BACKGROUND

There is a wireless tag reader system that reads data from a wireless tag using an RFID (Radio Frequency Identification) reader and then registers sales data of a commodity to which the wireless tag has been attached. The RFID reader can collectively read data from a plurality of wireless tags in a reading range of an antenna of the reader. Every time the data of a wireless tag is read by the RFID reader, the system executes a commodity registration processing based on the data read from the tag. In general, the time required for such processing becomes longer as the number of wireless tags being read becomes larger. Therefore, it may be likely that an operator (such as a store customer or clerk) might begin to operate an input device other than the RFID reader before the tag reading processing ends. If another input device is operated in this scenario, an interrupt is output to stop the registration processing. This interrupt may be processed as an error. If the interrupt causes an error, a system operator needs to perform operation for releasing the error (clearing the error state).

### BRIEF DESCRIPTION OF THE DRAWINGS

FIG. 1 is a block diagram of a registration processing apparatus according to an embodiment.

FIG. 2 is a schematic diagram of a data structure recorded in an IC chip of a wireless tag attached to a commodity.

FIG. 3 is a flowchart of processing executed by a processor according to a reading control program.

FIG. 4 is a flowchart of tag reading processing.

FIG. 5 is a schematic diagram illustrating an example of an initial screen.

FIG. 6 is a schematic diagram illustrating an example of a registration screen.

FIG. 7 is a schematic diagram illustrating an example of a registration screen on which a notification image is displayed.

FIG. 8 is a schematic diagram illustrating an example of a registration screen after data of a wireless tag is read.

FIG. 9 is a schematic diagram illustrating an example of a payment screen.

### DETAILED DESCRIPTION

An object of embodiments is to provide a registration processing apparatus and a program for a registration processing apparatus system that can avoid errors due to an interrupt generated during a wireless tag reading process and thus eliminate the need for an operator to clear the error.

According to an embodiment, a wireless tag reader data processing apparatus includes a reading device interface configured to receive data read from wireless tags by a reading device and a user input device interface configured to receive data from a user input device. A processor of the apparatus is configured to disable an input from the user input device while the reading device is reading the data of the wireless tag.

A registration processing apparatus according to one embodiment is explained below with reference to the drawings.

This embodiment illustrates a product registration processing apparatus configured to register, based on data of a wireless tag read by an RFID reader, sales data of a commodity to which the wireless tag is attached.

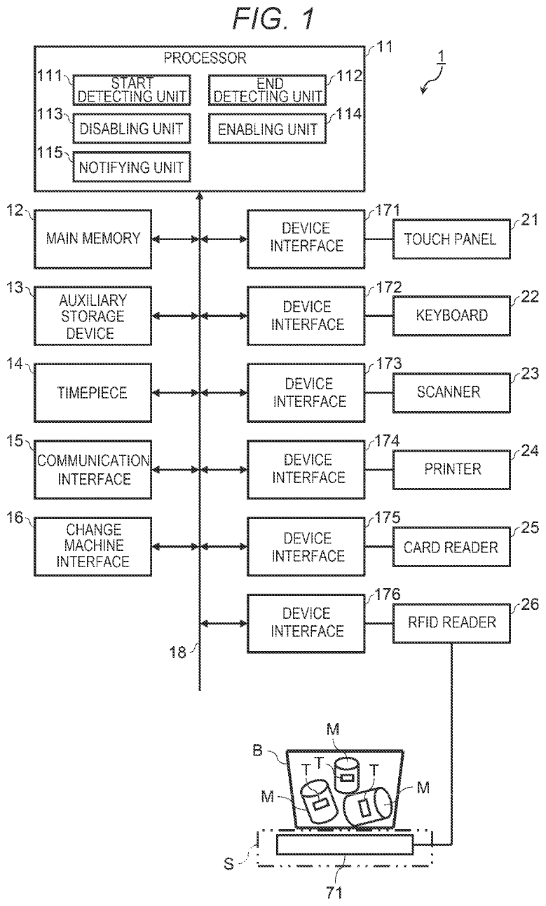

FIG. 1 is a block diagram illustrating an information processing apparatus 1 (registration processing apparatus) according to this embodiment. The information processing apparatus 1 includes a processor 11, a main memory 12, an auxiliary storage device 13, a timepiece 14 (clock), a communication interface 15, a change machine interface 16, device interfaces 171, 172, 173, 174, 175, 176, and a system transmission line 18. The system transmission line 18 includes an address bus, a data bus, and a control signal line. In the information processing apparatus 1, the processor 11, the main memory 12, the auxiliary storage device 13, the time piece 14, the communication interface 15, the change machine interface 16, and the plurality of device interfaces 171 to 176 are connected by the system transmission line 18 to form a computer. Various devices (peripheral devices) such as a touch panel 21, a keyboard 22, a scanner 23, a printer 24, a card reader 25, and an RFID reader 26 are respectively connected to the device interfaces 171 to 176 of the computer. In this way, an information processing apparatus 1 that is capable of registering sales data of a commodity to which a wireless tag is attached is formed. The information processing apparatus 1 of this type is sometimes referred to as a commodity registration apparatus, a POS (Point Of Sales) terminal, or a commodity sales processing apparatus.

The processor 11 is equivalent to a central part of the computer. The processor 11 controls the various sub-units according to an operating system or application programs to realize the various described functions of the information processing apparatus 1. The processor 11 is, for example, a CPU (Central Processing Unit).

The main memory 12 includes a nonvolatile memory region and a volatile memory region. The main memory 12 stores the operating system and/or the application programs in the nonvolatile memory region. The main memory 12 sometimes stores, in the nonvolatile or volatile memory region, data necessary for the processor 11 to execute processing for controlling the sub-units. The main memory 12 uses the volatile memory region as a work area where data can be rewritten as appropriate by the processor 11. The nonvolatile memory region is, for example, a ROM (Read Only Memory). The volatile memory region is, for example, a RAM (Random Access Memory).

The auxiliary storage device 13 is, for example, an EEPROM (Electric Erasable Programmable Read-Only Memory), a HDD (Hard Disk Drive), or an SSD (Solid State Drive). The auxiliary storage device 13 saves data used by the processor 11 in performing various kinds of processing, data created by the processing in the processor 11, and the like. The auxiliary storage device 13 sometimes stores application programs.

The timepiece 14 tracks a date and time. The processor 11 processes, as a present date and time, the date and the time tracked by the timepiece 14.

The communication interface 15 is a circuit for performing data communication with a store server. The store server is used for tracking commodity sales in a store. In order to realize such a service, the store server includes a commodity data file in which commodity data such as commodity names and prices are saved in correlation with commodity codes identifying the tracked commodities and an aggregate data file in which the numbers of sold articles, sales amounts, and the like are aggregated in correlation with the commodity codes of the commodities.

The change machine interface 16 is a circuit for handling data communication with an automatic change machine. For example, the change machine interface 16 receives, from the automatic change machine, deposited amount data that is a total amount of bills or coins deposited to the automatic change machine. The change machine interface 16 transmits, to the automatic change machine, change data indicating a change amount due as calculated from a deposited amount and a payment due amount. The automatic change pays out bills or coins equivalent to the change due amount.

The device interface 171 is a circuit for handling data communication with the touch panel 21. The touch panel 21 is a display device capable of displaying display elements such as text characters, symbols, icons, and images on the display. The touch panel 21 is also an input device that detects a touch operation position on the display with a sensor and processes touch input on the display elements as user input/selections.

The device interface 172 is a circuit for handling data communication with the keyboard 22. The keyboard 22 is an input device on which various keys necessary for the information processing apparatus 1, for example, a tenkey pad (numeric keypad), a PLU (PRICE Look Up) key, a subtotal key, a closing key, a cancel key, and a clear key are disposed.

The device interface 173 is a circuit for handling data communication with the scanner 23. The scanner 23 is an optical input device that scans a machine-readable code such as a barcode or a two-dimensional code with light and reads the machine-readable code. The scanner 23 may be an input device of an imaging type that reads a machine-readable code from an image captured by a camera. The scanner 23 can read the machine-readable code attached to a commodity and also a machine-readable code displayed on a display of a smartphone or the like.

The device interface 174 is a circuit for handling data communication with the printer 24. The printer 24 is a printing device that prints data on paper corresponding to the transaction of a commodity trade (sales transaction) and dispenses a transaction receipt, a payment receipt, a warranty, or the like.

The device interface 175 is a circuit for handling data communication with the card reader 25. The card reader 25 is an input device that reads data from a card medium such as a credit card, an electronic money card, or a point program card and processes the read card data. The card reader 25 may be a magnetic card reader adapted to a magnetic card or may be an IC card reader adapted to an IC card. The magnetic card reader and the IC card reader may be concurrently used. The IC card reader may be an IC card reader of a noncontact type or may be an IC card of a contact type. The card reader may be a card reader writer including a data writing function.

The device interface 176 is a circuit for handling data communication with the RFID reader 26. The RFID reader 26 is a reading device that reads data from a wireless tag T present in a communication zone of an antenna 71. In this embodiment, the antenna 71 is provided on a table S on which a shopping basket B can be placed. If a shopping basket B storing a plurality of commodities M is placed on the table S, the RFID reader 26 communicates with each of the wireless tags T attached to the commodities M and collectively reads data recorded in IC chips of these wireless tags T. That is, the RFID reader 26 is a reading device capable of collectively reading data from a plurality of wireless tags T at substantially the same time when such wireless tags T are each present in the communication zone of the antenna 71. The RFID reader 26 may be an RFID reader-writer capable of writing data in the IC chips of the wireless tags T. The wireless tag T may be referred to as RFID tag, RF tag, electronic tag, or the like. However, in this embodiment, the terminology wireless tag is adopted.

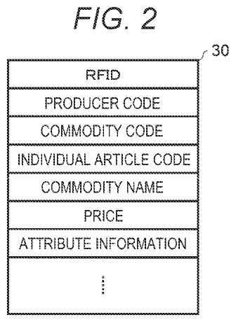

FIG. 2 is a schematic diagram illustrating a data structure recorded in the IC chip of the wireless tag T attached to the commodity M. As illustrated in FIG. 2, in the wireless tag T, an RFID tag code (“RFID”), a producer code, a commodity code, an individual article code, a commodity name, a price, attribute information, and the like are recorded as an item of tag data 30.

The RFID tag code is a unique identification code set for each of the wireless tags T in order to individually identify the wireless tags T. Specific RFID tag codes are recorded in the wireless tags T in advance. The producer code is a unique identification code set for different producers or manufacturers in order to identify the producers, the manufactures, or the like of the commodities M. The commodity code is a unique identification code set for each type or class of the commodities M in order to identify the commodities M by type or class. The individual article code is a unique identification code set individual articles in order to respectively identify the individual instances (articles) of the commodities M specified by commodity codes. The commodity name is a name representing the article specified by the commodity code. The price is a unit price set for the commodity M type/class specified by the commodity code. The attribute information is information concerning an attribute of the commodity M specified by the commodity code or the article. The attribute is, for example, a tax treatment type. As the tax treatment types, there may be an exclusive tax, an inclusive tax, tax-free.

The tag data 30 is not limited to an item configuration illustrated in FIG. 2. In general, the RFID tag code and some other information capable of identifying the commodity to which the wireless tag T has been attached are essential in the tag data 30. The other information items may or may not be included in the tag data 30. Information other than the items illustrated in FIG. 2 may also be included in the tag data 30.

Referring back to FIG. 1, the processor 11 functions as a control unit of the information processing apparatus 1. Specifically, the processor 11 provides the functions of a start detecting unit 111, an end detecting unit 112, a disabling unit 113, an enabling unit 114, and a notifying unit 115.

The start detecting unit 111 has a function of detecting a data reading start of a wireless tag T by the RFID reader 26. The end detecting unit 112 has a function of detecting a data reading end for a wireless tag T by the RFID reader 26. The disabling unit 113 has a function of disabling input from the input devices other than the RFID reader 26 upon the detection of the data reading start for a wireless tag T. The input devices in this context are the touch panel 21, the keyboard 22, the scanner 23, and the card reader 25. The enabling unit 114 has a function of enabling input from the other input devices according to the detection of the data reading end of the wireless tag T. The notifying unit 115 has a function of notifying that the input from the input devices is disabled. The notifying unit 115 notifies, for example, using the touch panel 21 that is also a display device, to display that the input from the other input devices is disabled. The notifying unit 115 in some examples may notify by using a sound output device to output sound (tones, beeps, voice, etc.) to indicate that the input from the other input devices is disabled.

The functions of the start detecting unit 111, the end detecting unit 112, the disabling unit 113, the enabling unit 114, and the notifying unit 115 are realized by information processing executed by the processor 11 according to a reading control program. The reading control program is a type of application software installed in the main memory 12 or the auxiliary storage device 13. A method of installing the reading control program in the main memory 12 or the auxiliary storage device 13 is not particularly limited. The reading control program can be recorded in a removable recording medium or can be distributed by communication via a network and installed in the main memory 12 or the auxiliary storage device 13. The form of the recording medium may be any format so long as the recording medium can store programs like a CD-ROM, a memory card, or the like and a device can read the recording medium.

The information processing apparatus 1 having such a configuration is installed at, for example, a checkout place of a store. A customer visiting the store puts the commodities M to be purchased in a shopping basket B or places the commodities M in a shopping cart while shopping on a selling floor where commodities are displayed and then carries the commodities M to the checkout place and places the commodities M on the table S for purchase (registration). The tag data 30 of the wireless tags T respectively attached to the commodities M placed on the table S are read by the RFID reader 26. The reading of these wireless tags T may be performed by the RFID reader 26 at substantially the same time in a collective manner or in quick succession. The information processing apparatus 1 registers sales data of the commodities M based on the tag data 30 read from the wireless tags T.

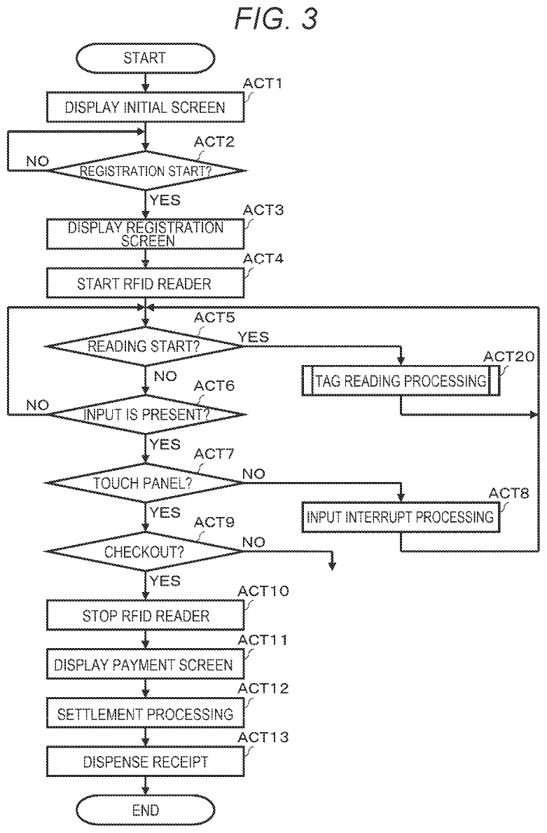

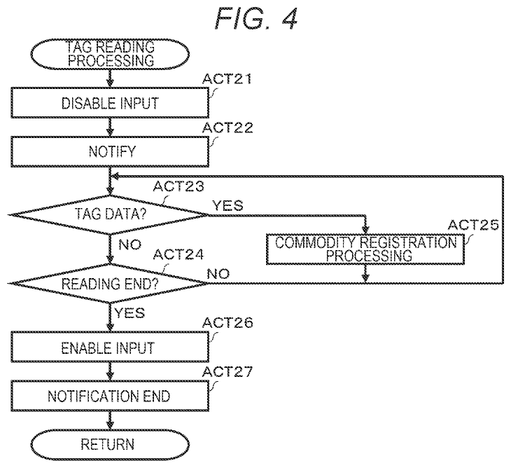

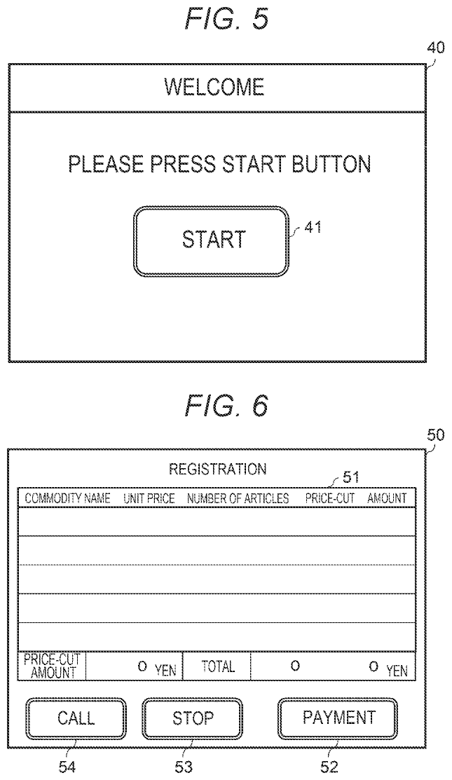

Information processing executed by the processor 11 according to the reading control program is explained with reference to flowcharts of FIGS. 3 and 4 and screen examples are illustrated in FIGS. 5 to 9. The procedure and content of the information processing explained below are non-limiting examples. The procedure and the content are not particularly limited so long as the same or substantially the same results can be obtained. The screen examples are also only examples and can be changed and implemented as appropriate.

First, in ACT 1 in FIG. 3, the processor 11 causes, via the device interface 171, the touch panel 21 to display an initial screen 40 (see FIG. 5). The initial screen 40 is a screen for a registration start selection to be made by an operator. The operator may be a store clerk or may be a customer. In the following example, it is assumed that the operator is a customer. That is, it is assumed that the information processing apparatus 1 is a POS terminal of a full self-service type by which the customer performs the commodity registration tasks and then performs the payment operations for the registered items without substantial assistance or intervention from a store clerk.

FIG. 5 is a schematic diagram illustrating an example of the initial screen 40. As illustrated, a “start” button 41 is displayed on the initial screen 40 as an operation element for receiving a registration start instruction. The “start” button 41 is a display element reproduced on the initial screen 40 as a softkey. The customer who placed the commodities M on the table S operates the “start” button 41.

The processor 11 waits for a registration start instruction in ACT 2. Upon detecting, as a signal from the touch panel 21 input via the device interface 171, that the “start” button 41 of the initial screen 40 was operated, the processor 11 regards that the registration start instruction was received. The processor 11 proceeds from ACT 2 to ACT 3. In ACT 3, the processor 11 changes, via the device interface 171, a screen of the touch panel 21 from the initial screen 40 to a registration screen 50 (see FIG. 6).

FIG. 6 is a schematic diagram illustrating an example of the registration screen 50. As illustrated, a details list 51 is displayed on the registration screen 50. The details list 51 is a region for displaying commodity names, prices (unit prices), the numbers of sold articles (the numbers of articles), price-cut amounts (price cuts), and sales amounts (amounts) of registered commodities in a list format and displaying totals of the price-cut amounts, the numbers of sold articles, and the sales amounts. On the registration screen 50, a “payment” button 52 is displayed as an operation element for receiving a command for transition to checkout, a “stop” button 53 is displayed as an operation element for receiving a registration stop instruction, and a “call” button 54 is displayed as an operation element for receiving a store clerk call instruction. The “payment” button 52, the “stop” button 53, and the “call” button 54 are display elements reproduced on the registration screen 50 as softkeys. A customer who finishes registration of the commodities M to be purchased and transitions to checkout selects the “payment” button 52. A customer who stops registration of the commodities M before completion/payment selects the “stop” button 53. For example, a customer who desires to call a store clerk because an error occurred selects the “call” button 54.

In ACT 4, the processor 11 outputs a start signal to the RFID reader 26 via the device interface 176. The RFID reader 26 starts an operation for repeatedly reading, at a fixed interval, the tag data 30 of the wireless tags T present in the communication region of the antenna 71. If the tag data 30 of a new wireless tag T is read in the operation, a reading start command is output from the RFID reader 26 to the information processing apparatus 1.

In ACT 5, the processor 11 checks, as the function of the start detecting unit 111, whether the reading start command was sent from the RFID reader 26. If the reading start command was not sent, the processor 11 proceeds from ACT 5 to ACT 6. In ACT 6, the processor 11 checks whether input from an input device other than the RFID reader 26 has been received. That is, the processor 11 checks whether input from the touch panel 21, the keyboard 22, the scanner 23, or the card reader 25 has been received. If there is no input from any of the input devices, the processor 11 returns from ACT 6 to ACT 5. In this way, in ACT 5 and ACT 6, the processor 11 waits for the reading start command to be sent or waits for input from an input device.

If input from an input device is received in the waiting state in ACT 5 and ACT 6, the processor 11 proceeds from ACT 6 to ACT 7. In ACT 7, the processor 11 checks whether the input device sending the input is the touch panel 21. If the input device is not the touch panel 21, the processor 11 proceeds from ACT 7 to ACT 8. In ACT 8, the processor 11 executes interrupt processing corresponding to the input source.

For example, if a key signal corresponding to an operation key is input from the keyboard 22 via the device interface 172, the processor 11 executes interrupt processing corresponding to the key signal. For example, if reading data of a machine-readable code is input from the scanner 23 via the device interface 173, the processor 11 executes interrupt processing corresponding to the machine-readable code. For example, if card data is input from the card reader 25 via the device interface 175, the processor 11 executes interrupt processing corresponding to the card data.

Since these kinds of interrupt processing are, in general, well-known processing that may be executed by an existing information processing apparatus of this type, detailed explanation of the interrupt processing for such input sources is omitted here. The processor 11 finishes the various interrupt processing and returns to the waiting state in ACT 5 and ACT 6. On the other hand, if the input device at the input source is the touch panel 21, the processor 11 proceeds from ACT 7 to ACT 9. Processing in ACT 9 and subsequent acts is explained below.

If the reading start command is sent from the RFID reader 26 via the device interface 176 in the waiting state in ACT 5 and ACT 6, the processor 11 proceeds from ACT 5 to ACT 20. In ACT 20, the processor 11 executes tag reading processing.

FIG. 4 is a flowchart illustrating a procedure of a tag reading processing. Upon starting the tag reading processing, in ACT 21, the processor 11 disables the ability to receive/process input from the input devices other than the RFID reader 26 as the function of the disabling unit 113. That is, the processor 11 outputs a Disable signal to the scanner 23 via the device interface 173 and disables the scanner 23 from operating. Similarly, the processor 11 outputs a Disable signal to the card reader 25 via the device interface 175 and disables the card reader 25 from operating. In this context, the processor 11 also neglects (ignores) all signals input to the device interface 171 from the touch panel 21. Similarly, the processor 11 neglects all signals input to the device interface 172 from the keyboard 22.

With such input disabling processing, even if the customer were to attempt to operate the scanner 23 or the card reader 25, the operation is not received or processed by the processor. Likewise, even if the customer operates the touch panel 21 or the keyboard 22, all such operations are ignored. Therefore, an error due to an interrupt input from any of the other input devices other than the RFID reader 26 does not occur.

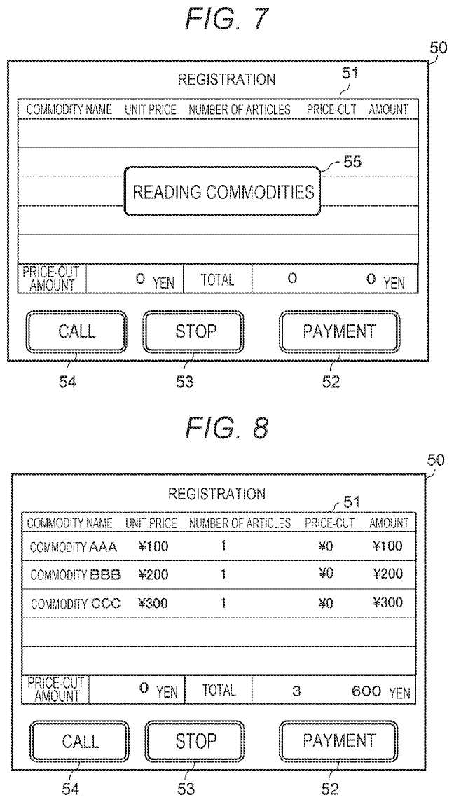

After ACT 21, the processor 11 proceeds to ACT 22. In ACT 22, the processor 11 notifies, as the function of the notifying unit 115, that the input from the input devices is disabled. Specifically, as illustrated in FIG. 7, the processor 11 causes the touch panel 21 to display on the registration screen 50 of the touch panel 21 an image 55 for notifying the operator that the input from the other input devices is disabled. In FIG. 7, the image 55 is an image including text “reading commodities”. The image 55 does not always have to be an image including the text “reading commodities”. The image 55 may be, for example, an image including text of content “the touch panel, the keyboard, and the like cannot be operated because commodities are being read”. Alternatively, the image 55 may be an image including text “operation prohibited”. The customer who sees the image 55 can easily determine that a user cannot operate the input devices such as the touch panel 21, the keyboard 22, the scanner 23, and the card reader 25 at this time.

The processor 11 that ends the processing in ACT 22 proceeds to ACT 23. In ACT 23, the processor 11 checks whether tag data 30 was input from the RFID reader 26. If tag data 30 was not input, the processor 11 proceeds from ACT 23 to ACT 24. In ACT 24, the processor 11 checks, as the function of the end detecting unit 112, whether a reading end command was sent from the RFID reader 26. If the reading end command was not sent, the processor 11 returns from ACT 24 to ACT 23. In this way, in ACT 23 and ACT 24, the processor 11 waits for all the tag data 30 to be input from the RFID reader 26 or waits for the reading end command to be sent from the RFID reader 26.

As explained above, the RFID reader 26 repeatedly attempts to read tag data 30 of the wireless tags T present in the communication region of the antenna 71. Upon reading the tag data 30 of a new wireless tag T (a presently unregistered wireless tag T), the RFID reader 26 outputs a reading start command to the information processing apparatus 1. Subsequently, the RFID reader 26 outputs the tag data 30 as read from the new wireless tag T to the information processing apparatus 1. In this process, if reading tag data 30 from more than one wireless tag T is read in one reading attempt period, the RFID reader 26 sequentially outputs the tag data 30 for each wireless tag T to the information processing apparatus 1. On the other hand, after performing the reading operation for a fixed number of times (attempts) without reading tag data 30 of a new wireless tag T, the RFID reader 26 outputs a reading end command to the information processing apparatus 1.

If tag data 30 is input via the device interface 176 in the waiting state in ACT 23 and ACT 24, the processor 11 proceeds from ACT 23 to ACT 25. In ACT 25, the processor 11 executes commodity registration processing based on the newly received tag data 30. That is, the processor 11 generates commodity sales data using a commodity code, a commodity name, a price, and the like included in or provided by the tag data 30. The commodity sales data can be data including the number of sold articles, a price-cut amount, and a sales amount in addition to the commodity code, the commodity name, and the price. The processor 11 registers the commodity sales data in a list memory. The list memory is a work area that is formed in the nonvolatile memory region of the main memory 12 and is cleared in response to instruction operation for a registration start. The processor 11 causes the touch panel 21 to display, in the details list 51 of the registration screen 50, the commodity name, the price, the number of sold articles, the price-cut amount, and the sales amount of the commodity sales data. The processor 11 updates a total price-cut amount, a total number of articles, and a total amount of the details list 51 to latest values.

Upon finishing the commodity registration processing, the processor 11 returns to the waiting state in ACT 23 and ACT 24. Therefore, if additional tag data 30 is sent from the RFID reader 26, the processor 11 executes the commodity registration processing again.

If a reading end command is sent via the device interface 176 in the waiting state in ACT 23 and ACT 24, the processor 11 proceeds from ACT 24 to ACT 26. In ACT 26, the processor 11 enables the input from the input devices other than the RFID reader 26 as the function of the enabling unit 114. That is, the processor 11 outputs an Enable signal to the scanner 23 via the device interface 173 and thus enables the scanner 23 to operate. Similarly, the processor 11 outputs an Enable signal to the card reader 25 via the device interface 175 and enables the card reader 25 to operate. The processor 11 captures all signals input from the touch panel 21 via the device interface 171. Similarly, the processor 11 captures (as opposed to ignores) all signals input from the keyboard 22 via the device interface 172.

With such input enabling processing, if the customer operates the scanner 23 or the card reader 25, the operation is received and processed as appropriate. Similarly, if the customer operates the touch panel 21 or the keyboard 22, all operation is received and processed as appropriate.

The processor 11 proceeds to ACT 27. In ACT 27, the processor 11 stops the notification that the input from the input devices is disabled. For example, the processor 11 erases the image 55 displayed on the registration screen 50. Since the image 55 is erased, the customer can determine that the input devices such as the touch panel 21, the keyboard 22, the scanner 23, and the card reader 25 can be operated.

After ACT 27, the processor 11 leaves the tag reading processing. The processor 11 returns to the waiting state in ACT 5 and ACT 6 in FIG. 3.

FIG. 8 is an example of the registration screen 50 after the reading end command is sent from the RFID reader 26. FIG. 8 represents that the tag data 30 of three wireless tags T, respectively attached to three different commodities M, was read by the RFID reader 26 in the tag reading processing. As illustrated, commodity names, prices, the numbers of sold articles, price-cut amounts, and sales amounts of the commodities M of the three articles are displayed in the details list 51 of the registration screen 50. The total price-cut amount, the total number of articles, and the total amount are updated to latest values.

In this example, if the customer intended to purchase four articles, for example, a commodity AAA, a commodity BBB, a commodity CCC, and a commodity DDD, but only data for three of the four articles, for example, the commodity AAA, the commodity BBB, and the commodity CCC are displayed, it can be regarded that there was an omission in reading of the tag data 30 by the RFID reader 26. For example, if the wireless tag T attached to the commodity DDD overlaps the wireless tag T of another commodity or the wireless tag T touches a metal portion of another commodity, a reading omission sometimes occurs. In such a case, the customer may shift the position of the commodity DDD by, for example, shaking the shopping basket B. Then, the tag data 30 of the wireless tag T attached to the commodity DDD may sometimes be read by the RFID reader 26 and the reading omission cured.

If the tag data 30 of a new wireless tag T is read, the processor 11 proceeds from ACT 5 to ACT 20. That is, the processor 11 executes, as explained above, the tag reading processing explained with reference to FIG. 4. As a result, commodity sales data of the commodity DDD is registered. A commodity name, a price, the number of sold articles, a price-cut amount, and a sales amount of the commodity DDD are added to the details list 51 and the total price-cut amount, the total number of articles, and the total amount are updated. At this time as well, input of the input devices other than the RFID reader 26 is disabled. Therefore, an error is not caused by input operation of the input devices. Thereafter, if a reading end command is output from the RFID reader 26, input of all the input devices is enabled.

On the other hand, for example, if the wireless tag T attached to the commodity DDD is broken (malfunctioning), the tag data 30 of the wireless tag T will not be read even if the position of the commodity DDD is shifted. As a result, registration omission of the commodity DDD occurs. In this case, the customer may operate the scanner 23 and scan a barcode attached to the commodity DDD. At this time, since input of the scanner 23 is enabled, the commodity DDD is registered according to barcode data. Alternatively, the customer operates the tenkey pad and the PLU key of the keyboard 22 and manually inputs a commodity code of the commodity DDD. At this time, since input of the keyboard 22 is enabled, the commodity DDD is registered according to key data. These kinds of processing are examples of the input interrupt processing in ACT 8 in FIG. 3.

Next, processing in ACT 9 and subsequent acts in FIG. 4 is explained.

If the operated input device is the touch panel 21, the processor 11 proceeds to ACT 9. In ACT 9, the processor 11 checks whether transition to checkout was instructed. If detecting, via a signal from the touch panel 21 input via the device interface 171, that the “payment” button 52 of the registration screen 50 was operated, the processor 11 determines that transition to checkout was instructed.

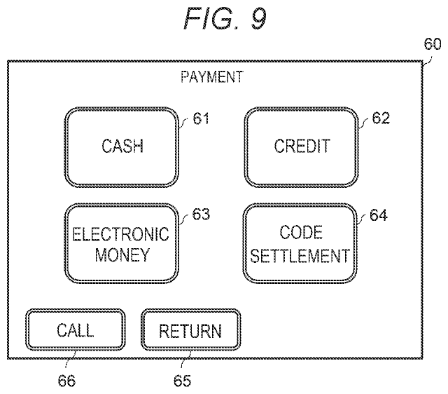

If the transition to the checkout was instructed, the processor 11 proceeds from ACT 9 to ACT 10. In ACT 10, the processor 11 outputs a stop signal to the RFID reader 26 via the device interface 176. The RFID reader 26 stops the reading operation for the wireless tags T. In ACT 11, the processor 11 transitions the screen of the touch panel 21 from the registration screen 50 to a payment screen 60 (see FIG. 9). In this way, in the information processing apparatus 1 in which the screen of the touch panel 21 was transitioned to the payment screen 60, since the RFID reader 26 is stopped, the wireless tag T of a new commodity is not read.

FIG. 9 is a schematic diagram illustrating an example of the payment screen 60. As illustrated, on the payment screen payment method selection buttons including a “cash” button 61, a “credit” button 62, an “electronic money” button 63, and a “code settlement” button 64, a “return” button 65, and a “call” button 66 are displayed. The “cash” button 61 is an operation element for receiving an instruction for payment by cash. The “credit” button 62 is an operation element for receiving an instruction for payment by a credit card. The “electronic money” button 63 is an operation element for receiving an instruction for electronic money payment. The “code settlement” button 64 is an operation element for receiving an instruction for code settlement. The “return” button 65 is an operation element for receiving an instruction to return to the registration screen 50 from the payment screen 60. The “call” button 66 is an operation element for receiving a store clerk call request. The buttons 61 to 66 are display elements reproduced on the payment screen as softkeys or icons.

The customer checks the payment screen 60 then selects a desired payment method selection button. For example, a customer desiring cash payment presses the “cash” button 61. A customer desiring credit card payment presses the “credit” button 62. The same applies to a customer desiring electronic money payment or code settlement payment. A customer desiring to return to the registration screen 50 because, for example, a commodity registration omission occurred presses the “return” button 65. A customer desiring to call a store clerk presses the “call” button 66.

The processor 11 then proceeds to ACT 12. In ACT 12, the processor 11 executes settlement processing according to the selected payment method. That is, if the “cash” button 61 is operated, the processor 11 executes cash settlement processing. If the “credit” button 62 is operated, the processor 11 executes credit card settlement processing. If the “electronic money” button 63 is operated, the processor 11 executes electronic money settlement processing. If the “code settlement” button 64 is operated, the processor 11 executes code settlement processing. Since these kinds of settlement processing are well-known processing, explanation of the settlement processing is omitted here.

The processor 11 then proceeds to ACT 13. In ACT 13, the processor 11 causes the printer 24 to operate and controls dispensing of a transaction receipt. Then, the processor 11 ends information processing relating to the transaction conforming to the reading control program.

In ACT 9, if the input from the touch panel 21 is not for instructing the transition to the checkout, the processor 11 executes other information processing as appropriate. For example, if the registration stop instruction is input by the operation of the “stop” button 53, the processor 11 executes information processing for stopping registration at that point in time. For example, if the store clerk call instruction is input by the operation of the “call” button 54, the processor 11 executes processing for calling a store clerk.

As explained above, in the information processing apparatus 1 in this embodiment, input of the input devices other than the RFID reader 26 (that is, the touch panel 21, the keyboard 22, the scanner 23, and the card reader 25) is disabled while the tag data 30 of the wireless tags T are being read by the RFID reader 26. Therefore, an error is not caused by an interrupt input in a period in which information processing for the tag data 30 is being performed. As a result, since an error due to the interrupt input in the information processing period can be prevented, it is possible to reduce the need for operations for releasing such errors. Accordingly, even if the operator is a customer, since an unnecessary error does not occur, it is possible to reduce the number of times an inefficient event such as a call for a store clerk occurs. It is possible to improve processing efficiency of the information processing apparatus 1.

The information processing apparatus 1 according to the embodiment is explained above. However, such an embodiment is not limited to the above.

In the embodiment, an information processing apparatus 1 is illustrated that registers, based on the tag data of the wireless tag T read by the RFID reader 26, the sales data of the commodity M to which the wireless tag T is attached. As an example of the information processing apparatus 1, a POS terminal of the full self-service type is assumed. As an example of the information processing apparatus 1, a registration machine in a POS system of a semi-self-service type may be assumed.

An information processing apparatus including a reading device that reads data of the wireless tag T, for example, the RFID reader 26 and the other input devices can achieve the same action effects as the action effects of the embodiment by providing the functions of the start detecting unit 111, the end detecting unit 112, the disabling unit 113, and the enabling unit 114. That is, the present invention can also be applied to an information processing apparatus other than the information processing apparatus called commodity registration apparatus, POS terminal, commodity sales processing apparatus, or the like.

In the embodiment, the processor 11, which is the control unit of the information processing apparatus 1, disables the input from the input devices while the reading device is reading the data of the wireless tag. In this regard, the processor 11 may disable the input from the input devices excluding at least some of the input devices while the reading device is reading the data of the wireless tag. For example, in an embodiment, the processor 11 disables the input from input devices but still enables (permits) input associated with the “stop” button 53 of the touch panel 21 on which the registration screen 50 is displayed. The processor 11 does not regard in this context interrupt processing due to operation of the “stop” button 53 as an error. Consequently, it is possible to permit a stop of registration even while the tag data of the wireless tag T is being read. Similarly, the processor 11 disables input from the input devices but still enables (permits) input associated with the “call” button 54 of the touch panel 21 on which the registration screen 50 is displayed. The processor 11 does not regard, in this context, interrupt processing due to input of the “call” button 54 as an error. Consequently, it is possible to permit a call to a store clerk even while the tag data of the wireless tag T is being read.

In some examples, the processor 11 only disables some types of input from a particular input device during the reading of the wireless tags T. For example, in an embodiment, it is likely that the operator may attempt to manually register a commodity while the RFID reader 26 is reading tag data 30 of the wireless tags T. Therefore, the processor 11 may selectively disable input from the scanner 23 and the operation of the PLU key on the keyboard 22. By performing such a selective disablement, it is possible to reduce a frequency of errors during the operation of the tag reading device.

Besides, while several embodiments are explained above, these embodiments are presented as examples and are not intended to limit the scope of invention. These new embodiments can be implemented in other various forms. Various omissions, substitutions, and changes can be made in a range not departing from the gist of the invention. These embodiments and modifications thereof are included in the claims and included in the inventions described in the claims and a scope of equivalents of the inventions.

What is claimed is:

1. A wireless tag reader data processing apparatus, comprising:
a reading device interface configured to receive data read from wireless tags by a reading device;
a user input device interface configured to receive data from a user input device; and
a processor configured to disable an input from the user input device while the reading device is reading the data of the wireless tag.

2. The wireless tag reader data processing apparatus according to claim 1, wherein the processor is further configured to:
detect a data reading start of the reading device;
detect a data reading end by the reading device;
disable the input from the user input device upon detection of the data reading start; and
enable the input from the user input device upon the detection of the data reading end.

3. The wireless tag reader data processing apparatus according to claim 2, wherein the processor is further configured to cause a notification to be output to indicate to a user that the input from the user input device is disabled.

4. The wireless tag reader data processing apparatus according to claim 1, wherein the processor is further configured to cause a notification to be output to indicate to a user that the input from the user input device is disabled.

5. The wireless tag reader data processing apparatus according to claim 1, wherein the processor is configured to disable all inputs from user to the user input device while the reading device is reading the data of the wireless tag.

6. The wireless tag reader data processing apparatus according to claim 1, wherein the processor is configured to disable some but not all inputs from user to the user input device while the reading device is reading the data of the wireless tag.

7. The wireless tag reader data processing apparatus according to claim 1, wherein the processor is further configured to register commodity sales data in a sales transaction based on the data of the wireless tag read by the reading device.

8. A point-of-sale apparatus, comprising:
a reading device configured to read data from wireless tags;
a user input device configured to receive user input; and
a processor configured to disable an input from the user input device while the reading device is reading the data of a wireless tag.

9. The point-of-sale apparatus according to claim 8, wherein the processor is further configured to:
detect a data reading start of the reading device;
detect a data reading end by the reading device;
disable the input from the user input device upon detection of the data reading start; and
enable the input from the user input device upon the detection of the data reading end.

10. The point-of-sale apparatus according to claim 9, wherein the processor is further configured to cause a notification to be output to indicate to a user that the user input from the user input device is disabled.

11. The point-of-sale apparatus according to claim 8, wherein the processor is further configured to cause a notification to be output to indicate to a user that the user input from the user input device is disabled.

12. The point-of-sale apparatus according to claim 8, wherein the processor is configured to disable all inputs from user to the user input device while the reading device is reading the data of the wireless tag.

13. The point-of-sale apparatus according to claim 8, wherein the processor is configured to disable some but not all inputs from user to the user input device while the reading device is reading the data of the wireless tag.

14. The point-of-sale apparatus according to claim 8, wherein the processor is further configured to register commodity sales data in a sales transaction based on the data of the wireless tag read by the reading device.

15. The point-of-sale apparatus according to claim 8, wherein the reading device is an RFID tag reader.

16. An information processing method for a wireless tag reader data processing apparatus, the information processing method comprising:
detecting a data reading start of a reading device configured to read data from wireless tags;
detecting a data reading end of the reading device;
disabling an input from a user input device upon detection of the data reading start; and
enabling the input from the user input device upon the detection of the data reading end.

17. The information processing method according to claim 16, wherein the reading device is an RFID tag reader.

18. The information processing method according to claim 16, further comprising:
causing a notification to be output to indicate to a user that the input from the user input device is disabled.

19. The information processing method according to claim 16, further comprising:
registering commodity sales data in a sales transaction based on the data of a wireless tag read by the reading device.
